(19) United States
(12) Patent Application Publication
(10) Pub. No.: US 2025/0215856 A1
(43) Pub. Date: Jul. 3, 2025

(54) METHOD FOR ASSEMBLING AN OFFSHORE SUPPORT STRUCTURE FOR A WIND TURBINE

(71) Applicant: STIESDAL OFFSHORE A/S, Give (DK)

(72) Inventor: Henrik STIESDAL, Odense C (DK)

(21) Appl. No.: 18/865,275

(22) PCT Filed: Nov. 23, 2022
(86) PCT No.: PCT/DK2022/050247

§ 371 Date: Nov. 12, 2024

(30) Foreign Application Priority Data
Feb. 14, 2022 (DK) PA202200122

(51) Int. Cl. F03D 13/25; B63B 21/50; B63B 75/00; E02B 17/00; E02B 17/02; E02D 27/52

(52) U.S. Cl. CPC F03D 13/256; B63B 21/50; B63B 75/00; E02B 17/025; E02D 27/525; E02B 2017/0091; E02D 2300/002; E02D 2300/0029; E02D 2600/20; F05B 2230/60; F05B 2240/93; F05B 2240/95

(57) ABSTRACT

In the assembly of an offshore support structure for a wind turbine, tubular braces are interconnected or connected to a tower support in casted connections where an end part of the corresponding brace is inserted into a cavity of a concrete-casted shell unit that is fixed onto the outer surface of the inter-connecting brace or on the outer surface of the tower support, and the volume in the cavity is filled by a hardening fixation material, typically grout, after insertion of the corresponding brace.

### FIELD OF THE INVENTION

The present invention relates to method of assembly and optionally also including installation of an offshore support structure for a wind turbine. In particular, it relates to a method as per the preamble of the independent claim.

### BACKGROUND OF THE INVENTION

For offshore structures, for example for supporting wind turbines, tetrahedral structures are advantageous in a high degree of stability, while on a relative scale requiring only moderate costs. Examples of such structures are disclosed in international patent application WO2017/157399.

In order to optimize ways of production, while at the same time to reduce and minimize production costs, which makes offshore wind energy parks increasingly attractive, there is a steady effort to find improvements in the production and assembly procedure.

Japanese patent application JP2000087504A discloses a method for providing an off-shore tower structure where ends of connecting tubes are inserted through openings into larger braces, and a grout cast is filling a portion of the larger brace and an end portion of the tube, which is provided with shear keys for additional stabilization.

The fact that grout is inserted in the entire tubular structure implies a large consumption of grout. Furthermore, for floating structures, filling braces with grout decreases buoyancy, which is not wanted. It would be desirable to reduce the consumption of grout while safeguarding a high degree of stability and rigidity.

A smaller consumption of grout is used in the system of WO2013/156110, which discloses a lattice tower for wind turbines. The lattice tower has tubular corner legs and tubular struts connecting the corner legs. For connection to the legs, the struts have node shells abutting the corner legs along a partial circumferential region, so that multiple node shells form a ring or partial ring around the corner leg. The node shells are made of cast steel to which the struts are welded. The shells are fastened to the legs by welding, gluing, or grouting. Optionally, a ring flange is fastened to and around the leg, so that the shells can rest on this ring flange for better stability.

Cast steel shells of the type as disclosed in WO2013/156110 have to be prepared in an iron melting facility, which is typically far away from the construction and assembly site for offshore support structures. As the shells are cast and not made from rolled iron, their production is also at a different site than the production site for the tubular braces of wind turbine offshore support structures, which are typically rolled and welded. Accordingly, such cast steel shells add to the complexity of production and shipment of the components for the offshore structure to the assembly site, which goes against the aim of reducing cost, assembly-time and complexity for offshore wind turbine production facilities. In particular, offshore wind turbine support structures are typically assembled near or in harbors, where the large tubes are interconnected, for example forming a tetrahedral structure. It would be desirable to provide an assembly method where connecting tubes for the offshore structure are connected by grouting, but which does not have the disadvantages of the prior art. In particular, the cast steel shells should be avoided as fastening material.

It should be pointed out that the two above-mentioned disclosure of JP2000087504A and WO2013/156110 disclose two different and mutually e approaches. In JP2000087504A, the metal strut is inserted into a cavity of another metal tube in order to fasten the strut inside the tube, and in WO2013/156110, the metal strut is provided with a metal shell welded to its end, where the metal shell is fastened to an outer side of the metal tube.

Further grout connections are disclosed in U.S. Pat. No. 4,245,928 with respect to an offshore structure where piles are driven into the seabed and braces are fastened to the piles in order to provide stability. The braces are connected to the piles in joints that are fixed with cement. WO2011/147472 discloses a segmented jacket construction, in particular for a foundation for a wind turbine installation, which comprises grid segments that are interconnected by joints that comprise tubular modules bonded by a grouted material.

### DESCRIPTION/SUMMARY OF THE INVENTION

It is an objective of the invention to provide an improvement in the art. In particular, it is an objective to provide an improved construction method for offshore platforms for wind turbines, especially for tubular structures, optionally tetrahedral structures. Furthermore, it is an objective to provide a construction method for offshore platforms, especially for wind turbines, in which grouted connections are provided at ends of tubular segments and which in a relatively simple way allows assembly as well as minimization of grout consumption. A further objective is greater flexibility with respect to the grouted connections without the need of providing, in particular transporting, cast iron shells. One or more of these objectives as well as further advantages are achieved by a method of assembling and optionally also installing an offshore support structure for a wind turbine as described below and in the claims.

In short, in the assembly of an offshore support structure for a wind turbine, tubular braces are interconnected or connected to a tower support in cast connections where an end part of the corresponding brace is inserted into a cavity of a concrete-cast shell unit that is fixed onto the outer surface of the interconnecting brace or onto the outer surface of the tower support, and the volume in the cavity is filled by a hardening fixation material, typically grout, after insertion of the corresponding brace.

In contrast to the above-mentioned WO2013/156110, the shells are cast in concrete and not in cast steel. This has a great advantage in that the shells can be manufactured close to the site where the offshore structure is assembled. Thus, not only the material costs are lower but also the costs for production and transport.

Additionally, the concrete cast is simpler in setup and can readily be changed not only with respect to production number but also with respect to dimensions, the latter being an advantage when different sized structures are assembled. In particular, the casting molds can be readily adjusted for tower supports and braces of varying dimensions.

Accordingly, the provision of concrete cast shells is by far more flexible and adjustable than cast-steel shells.

Grouted connections are highly useful in combination with the concrete shells, in particular because grout binds very well to the concrete surface of the shell units.

As a further additional advantage, the concrete casting can be adjusted so that reinforcing steel profiles extend outside the shell unit for easier binding to adjacent surfaces, such as the outer surface of the brace or tower support as well as to neighboring shell units.

As an even further advantage for the concrete casting is a pretension of the cast shell units by reinforcing steel profiles extending through the cast concrete. These advantages are not achieved when providing shell units in cast steel.

It should also be pointed out that the weight of the concrete shell unit is lower than if cast in iron, which is advantageous for floating support structures especially when having in mind that the shell units have dimensions of several meters.

All in all, use of concrete shells with openings into which braces are inserted and fastened by grouting brings multiple advantages, neither disclosed nor foreseen in the prior art.

Details are explained in the following.

For the assembly, a first set of a number of N, for example N=3, 4, 5 or 6, of first tubular braces and a second set of N second tubular braces are provided in addition to a tower support, which will be used for carrying a wind turbine tower. These components are then assembled into a support structure.

Although, the assembly method is particularly useful for an offshore support structure with an offshore wind turbine, the generality of the method does not exclude that it is used as a support structure for an offshore platform of other types, for example a floating platform of a more general type.

For each pair of one of the first braces and one of the second braces, the second end part of the first brace is connected to a first part of the tower support at a first connection, and the second end part of the second tubular brace is connected to a second part of the tower support at a second connection. Further, the first end part of the second brace is connected to the first brace at a third connection. The second connection is above the first connection when the support structure is oriented for operation, where the wind turbine tower is in vertical orientation. Accordingly, the tower support, the first brace, and the second brace form a triangle in a vertical plane. Due to the triangular shape of the combination of the tower support, the radial brace, and the second brace, the second brace is also called diagonal brace. The N pairs of braces are directed outwards from the tower support in different directions about a vertical central axis of the tower support. For this reason, the first braces are also called radial braces.

The shell unit comprises a base portion having a first side and a second side, and a cavity portion extending from the first side of the base portion, the cavity portion comprising a cavity inside the cavity portion. The second side is fixed against the outer surface of a tower support or brace.

In the following, various specific embodiments are presented, in which cast, for example grouted, connections are used for interconnection between the braces and the tower support.

In a first embodiment, the method comprises providing the second side of the shell unit with a curvature corresponding to a curvature of an outer surface of the tower support and attaching the second side to the outer surface of the tower support by first hardening fixation material, for example glue but typically grout. The first connection is then provided by inserting the second end part of the first brace into the shell cavity and providing a rigid fixation between the first brace and the shell unit by filling a second hardening fixation material, for example glue but typically grout, into the shell cavity around the second end part of the first brace and solidifying the fixation material.

In a second embodiment, the method comprises providing the second side of the shell unit with a curvature corresponding to a curvature of an outer surface of the tower support and attaching the second side to the outer surface of the tower support by first hardening fixation material, for example glue but typically grout. The second connection is then provided by inserting the second end part of the second brace into the shell cavity and providing a rigid fixation between the second brace and the shell unit by filling a second hardening fixation material, for example glue but typically grout, into the shell cavity around the second end part of the second brace and solidifying the fixation material.

In a third embodiment, the method comprises providing the second side of the shell unit with a curvature corresponding to a curvature of an outer surface of the first brace and attaching the second side to the outer surface of the first brace by first hardening fixation material, for example glue but typically grout. The third connection is then provided by inserting the first end part of the second brace into the shell cavity and providing a rigid fixation between the second brace and the shell unit by filling a second hardening fixation material, for example glue but typically grout, into the shell cavity around the first end part of the second brace and solidifying the fixation material.

In some further embodiments, two of the above three embodiments or all three embodiments are combined.

For support of the shell units on the outer surface, typically, a support flange, for example ring flange, is fastened to the outer surface, for example welded thereto, and the shell unit is positioned against the flange for support of the shell units at its end. For example, two support flanges are provided at either end of the shell units, so that the shell unit is fixed and supported therein between.

Optionally, during positioning of the shell units on the outer surface, steel wires are tightened around the shell units and the brace or tower unit for holding and pulling the shell units towards the outer surface.

Advantageously, the second side of the base of the shell unit is provided with protrusions that rest against the outer surface, while creating a distance to the outer surface in between the protrusions in order for the fixation material, typically grout, to flow in the space between the protrusions in between outer surface and the second side of the base

The fixation material is fluidic or semi-fluidic, for example polymer or grout, which is then hardened to provide the solidified rigid casting. Grout is a preferred material due to its high rigidity and longevity in saltwater. In the following, grout is exemplified as the casting material, but it could be substituted by another casting material, if it is more appropriate or useful.

Advantageously, the outer surface underneath the shell unit is free from openings for preventing the first and the second hardening fixation material from flowing through the outer surface. This increases control of where exactly the fixation material is provided and avoids using excessive amounts of casting material, especially grouting material. For the same purpose, optionally, the connection the end parts of the braces are provided with closed ends.

Some useful embodiments have been found in the following. In these embodiments, the shell unit comprises reinforcing steel elements embedded in concrete of the shell unit, wherein the steel elements extend out of the concrete of the shell unit at an edge of the base. When assembling multiple shell units about a tower support or brace, the steel elements are used as connecting elements. In such cases, the method comprises providing a further shell unit with steel elements extending out of the concrete of the further shell unit at an edge of its base and fastening the further shell unit next to the shell unit with an intermeshing overlap of the steel elements extending out of the shell unit and the further shell unit in an overlap region. This overlap region is then filled with a third hardening fixation material, typically grout, and solidified for fixation the edges of the bases of the shell unit and the further shell unit to each other.

Alternatively, the shell unit comprises a first interlock part and the further shell unit a second interlock part, which are counterparts of an interlock. The further shell unit is then fastened next to the shell unit, and the first and second interlock parts are connected to form an interlock. Optionally a third hardening fixation material, typically grout, is filled into the interlock and solidified for securing the interlock.

For a seabed-fixed support structure, the rigid frame structure with tower support and N first braces and N second braces is typically sufficient for long term stability. For floating structures, such as Tension Leg Platforms (TLP) for wind turbine towers or semisubmersible platforms, it is desirable to provide additional stability. For this reason, as an option, the following extended embodiment is useful.

In this extended embodiment, a third set of N third braces, typically tubular braces, are provided for interconnecting the first braces by the third braces. The method described above with shell units as connectors are advantageously also used for the third braces, although, in principle, the third braces could also be connected to the first braces by welding or by connection to corresponding brackets.

For example, for N=4, the first braces form a cross with the tower support in the center, and the third braces stabilize the cross in the plane formed by the cross. Typically, the third set of N=4 braces form a square in which the first braces form the diagonals with. The first and third braces are optionally in a single plane. However, this is not strictly necessary. For example, the third braces form a square in one plane, and the first braces extend with their first end in the tower support out of such plane, for example below the plane of the square of the third braces. Furthermore, it is also not strictly necessary that the braces are equally long, and one or two of the first braces may be longer than the remaining two in order for the assembly of the N=4 third braces to deviate from a square and form a rectangle, instead.

Another, typically preferred example is for N=3, in which the third braces form a triangle, optionally with the tower in the center of the triangle. These third braces are also called side braces, as they form sides of a triangle. The first braces are also typically called radial braces, as they extend radially from the tower support to one of each of the corners in the triangle. Also, in this case, the first and third braces are optionally in a single horizontal plane. However, this is not strictly necessary. For example, the third braces form a triangle in one plane, and the first braces extend with their first end in the tower support out of such plane, for example below or above the horizontal plane of the triangle of the third braces. Furthermore, it is also not strictly necessary that the braces are equally long, forming an equilateral triangle, as the triangle need not necessarily be regular. Even further, it is possible that the tower support is not in the center of the triangle. For example, the tower support is provided on or near to one of the sides of the triangle.

Optionally, the interconnection of the first braces by the third braces involves interconnecting the ends of the first braces by the third braces. However, this is not strictly necessary, as the connection can be a distance offset from the ends.

For the case N=3, the assembly may result in a tetrahedral structure formed by the first, second and third braces, optionally formed as a regular tetrahedron. In this case, the first braces are radial braces that extend radially from the tower support. The third braces are side braces, as they form sides of a triangle. The second braces are diagonal braces, as they extends diagonally from the first braces to the tower support, each second brace forming a vertical triangle with the first brace and the tower support.

For example, the columns support is centered in the tetrahedral structure. Alternatively, it is off-centered, or the tower support is provided in a corner of the supper structure or along a side of a triangle between two nodes.

Once, the offshore support structure has been assembled, typically onshore or on land, a wind turbine is mounted on top of the structure. The assembly is then moved to a point of destination offshore, typically dragged along by vessels, and then anchored to the seabed, for example while maintaining the structure floating. As mentioned, examples are TLP, which typically are floating under water, and semi-submersibles, which are floating half submersed in the water at the surface.

In order to optimize strength and longevity of the grout connections, shear keys are advantageously used on the inserted portion of the braces.

The first and second braces are tubular, and typically also the third braces are tubular. Optionally, the tubular braces have volumes with positive buoyancy. Optionally, the volumes can be flooded for adjusting the buoyancy. In most general cases, the braces are straight.

As an example, braces optionally have a diameter in the range of 1 to 6 meter, the larger of which can be more than 50 meter long. Brace ends are optionally inserted a distance of 3 to 5 meter in the respective cavity.

Optionally, the tower support itself is tubular, for example cylindrical or conical or a combination thereof in adjacent sections of the tubular support structure.

### SHORT DESCRIPTION OF THE DRAWINGS

The invention will be explained in more detail with reference to the drawing, where

FIG. 1 discloses a tetrahedral structure for an offshore wind turbine;

FIG. 2A-E illustrate a sequence of assembly,

FIG. 3 is a transparent side view.

FIG. 4 illustrates base protrusions resting against the outer surface;

FIG. 5 illustrates an interlock between edges of shell units.

### DETAILED DESCRIPTION/PREFERRED EMBODIMENT

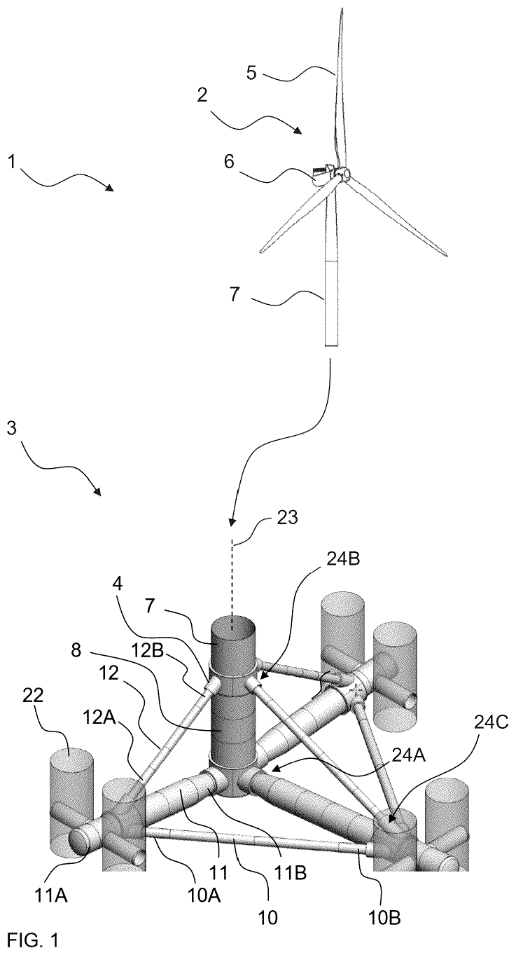

FIG. 1 illustrates an offshore wind turbine installation 1. The installation 1 comprises a wind turbine 2 and an offshore support structure 3 on which the wind turbine 2 is mounted for operation and by which it is supported in offshore conditions. The wind turbine 2 comprises a rotor 5 and a tower 7 as well as a nacelle 6 that connects the rotor with the tower 7.

The offshore support structure 3 comprises a tower support 8, onto which the tower 7 of the wind turbine 2 is mounted. Notice that the wind turbine 2 is not to scale with the support structure 3 but is shown at smaller scale for ease of illustration.

The offshore support structure 3 is exemplified as a tetrahedral floating structure with buoyancy tanks 22 pairwise attached to a grid structure at nodes of the tetrahedral structure. In operation, at least a portion of the buoyancy tanks 22 is under water. Alternatively, the structure could be bottom based, especially when used in shallow waters.

Typically, for deeper waters, floating structures are used, for example semisubmersible structures with mooring lines and buoyancy tanks 22 that keep the structure 3 floating partially submersed under water. The tubular grid structure itself provides additional buoyancy. Alternatively, the structure 3 could be a tension leg platform (TLP) with a fully submerged floating support structure. A floating support structure 3 would be held in its location by mooring lines that are fixed to the seabed 13.

The exemplified structure 3 has a tetrahedral shape with a tower support 8 mounted midway on one of the sides of a horizontal triangle of the tetrahedron. From a first, lower part of the tower support 8, first braces 11 extend largely radially outwards into different radial directions, so that these first braces 11 are also called radial braces 11. From a second, upper part of the tower support 8, second braces 12 extends to the first braces 11 so that the tower support 8 together with each set of one first brace 11 and one second brace 12 form a planar triangle. The second brace 12 is also called diagonal brace 12 due to the triangular shape of the combination of the tower support 8, the radial brace 11, and the second brace 12. A triangular basis for the tetrahedron is formed by each set of a side brace 10 and two radial braces 11. The side braces 10 are interconnecting the radial braces 11.

The first end 12A of each of the diagonal braces 12 connect to one of the radial braces 11, typically at a location at or near the first end 11A of the corresponding radial brace 11. The radial braces 11 connect with their second ends 11B to a first, lower part of the tower support 8, and the diagonal braces 12 connect with their second ends 12B to a second, upper part of the tower support 8.

The tower support 8 is exemplified as a support column but could have other shapes than illustrated.

As will be exemplified later in more detail, the connections between the braces 10, 11, 12 and the tower support 8 can be cast connections, for example grouted connections, where an end part 10A, 10B, 12A, 12b, of a side brace 10 or diagonal brace 12 is accommodated in a shell cavity of a shell unit 4 that is fastened to the surface of a radial brace 11, or where an end part 11B of a radial brace 11 is accommodated in a shell cavity of a shell unit 4 that is fastened to the surface of the tower support 8. The end part 10A, 10B, 11B, 12A, 12b, of the brace 10, 11, 12 in such shell cavity is then fastened to the shell unit 4 by a fixation material, typically grout, which is then hardened after insertion of the end part in order to provide a solidly fixed connection by means of the shell unit 4.

The fact that the surface 14 of the radial brace 11 or the tower support 8 is unbroken and without openings at the location where the shell units 4 are fastened to the surface is advantageous for the method as described herein, as it is a simplification relatively to prior art methods where diagonal braces 12 are extending through openings into radial braces 11 and into cavities inside the receiving radial braces 11. It also leads to consumption of much less grout.

Although, the system has been exemplified for a triangular, especially, tetrahedral structure, it is also applicable for other polygonal structures, for example having 4, 5 or 6 radial braces 11 and a corresponding number of diagonal braces 12. As a typical option, in order to end with a structure as illustrated in FIG. 1, side braces 10 are connected to the radial braces 11, which enhances rigidity.

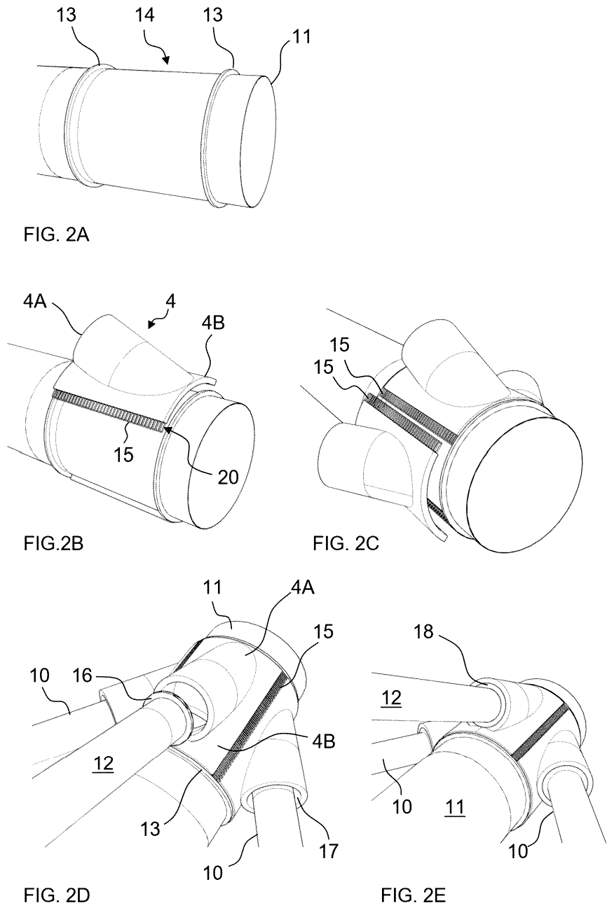

FIG. 2A through 2E illustrate an exemplified assembly method where shell units 4 are attached to a radial brace 11 and end portions of diagonal braces 12 are inserted into shell cavities 17 inside the shell units. As an alternative to the radial brace 11, shell units 4 are attached to the tower support 8, as illustrated in FIG. 1 according to a similar principle.

The illustrated section of a radial brace 11 in FIG. 2A has an unbroken surface 14 between two circular support flanges 13 that are fastened to the brace 11, typically welded, and between which the shell units 4 are attached to the radial brace 11, typically by grouting. The two flanges 13 have a distance corresponding to a length of the base portion 4B of the shell unit 4 so that the shell unit is provided there in between, optionally filling a minor spacing between the shell unit 4 and the support flanges 13 by a filling a fixation material, typically grout, into the minor spacing.

The shells units 4 are cast in concrete, which is an advantageous method as compared to providing shell units in cast metal as disclosed in the prior art, the latter being a far more expensive solution and does not have the same advantage of a production facility near the assembly location.

Concrete casting is relatively simple, and the material costs are far lower than for cast iron, especially when having in mind that the shell units have dimensions of several meters. An additional advantage is a much lower weight of the shell units 4 when cast in concrete, which is advantageous for floating support structures.

In FIG. 2B, a shell unit 4 is in the process of being attached to the radial brace 11, typically lifted and lowered by using a crane. The shell unit 4 comprises a cavity portion 4A with a cavity and a base portion 4B. The latter is abutting the surface 14 of the radial brace 11, once the shell unit 4 is fastened to the radial brace 11 by grout or other type of contact binder, for example glue.

As illustrated in FIG. 2C, four shell units 4 are placed around the radial brace 11 so as to extend all around the circumference of the radial brace 11. In the present exemplified case, only three of the shell units 4 are used for connecting to other braces 10, 12 by insertion into the corresponding shell unit 4. However, in other configurations, for example for N=4, four shell units 4 are optionally used for connecting four radial braces and/or diagonal braces to the tower.

It is possible that the shell units 4 are configured for an edge-to-edge configuration. However, as illustrated, a spacing is provided between the edges of the shell units 4. Into this spacing, steel profiles 15 extend from either of two adjacent edges of shell units 4 in overlapping configuration. Once, the shell units 4 have been placed around the radial brace 11, this overlap region 20 and spacing is sealed and fastened by intermeshing the steel profiles 15 inside the filling material for fixation, typically grout.

Once the shell units 4 have been placed around the radial brace 11, ends of a diagonal braces 12 and of side braces 10 are inserted into shell cavities 17, as illustrated in FIG. 2D, and the remaining spacing between the shell cavity 17 and the inserted brace 10, 12 is filled with a fixation material 18, typically grout, as illustrated in FIG. 2E.

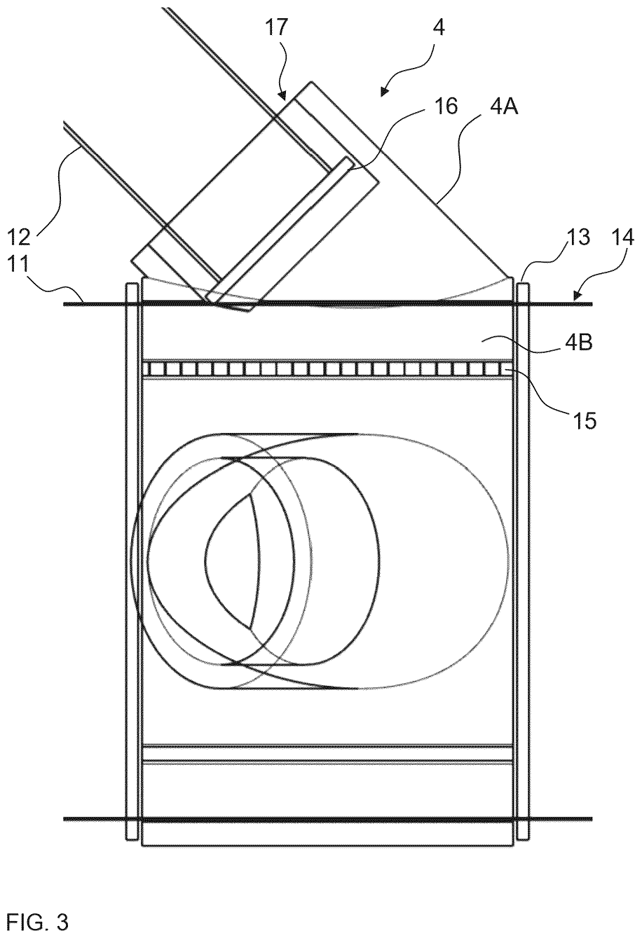

FIG. 3 shows a transparent side view drawing for better illustration of the radial brace 12 inside the shell cavity 17. It is observed that the brace 12 with its end flange 16 does only extend into the shell cavity 17 to a position where the end flange 16 contacts the unbroken outer surface 14 of the radial brace 11. The end flange 16 assist in axial stability of the fixed diagonal brace 11 inside the shell cavity 17 when the radial brace 12 is exposed to axial forces.

Optionally, as an alternative to the end flange 16 or as an additional measure, the inserted brace 10, 12 is provided with shear keys. As a further option, the inner side of the shell cavity 17 has a profiled surface, securing in axial direction and/or tangential direction for better grip in axial and/or rotational direction between the inserted brace 10, 12 and the shell unit 4 after filling of the cavity 17 with a hardening filling material, typically grout.

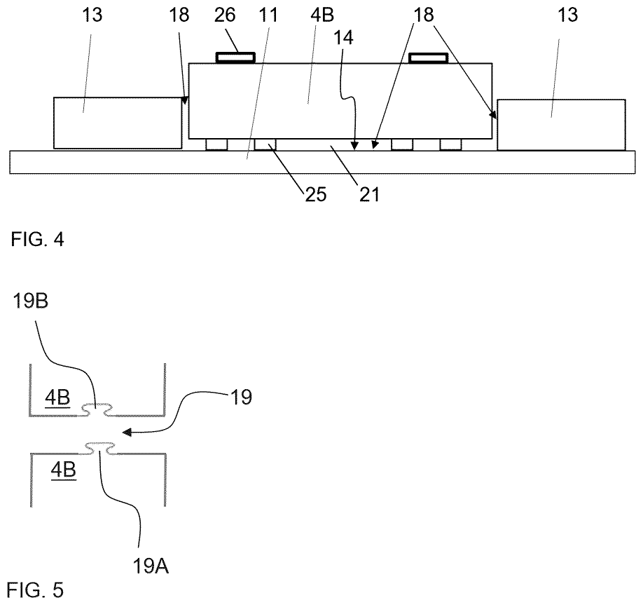

FIG. 4 illustrates an embodiment in which the base 4B is located in between two support flanges 13 have protrusions 25 in order to maintain a distance to the outer surface 14 and provide a volume 21 in which grout or other fluidic fixation material can be inserted for fastening the shell unit 4 against the surface 14. Also illustrated, as an option, is the use of a band clamp 26 around the brace 11 or tower unit 8 surrounding the shell units as well for holding the shell units 4 pressed against the outer surface 14.

FIG. 5 illustrates an alternative to the intermeshing steel profiles 15. In the exemplified embodiment, the edges of the shell units are provided with corresponding male part 19A and receiving female part 19B of an interlock 19. The interlock has an advantage of keeping the shell units in place radially, once the shell units 4 surround the corresponding brace 11 or tower support 4. Other known interlock principles are possible as alternatives.

1. A method for assembling an offshore support structure (3) for a wind turbine (2), the method comprising,
providing a tower support (8) for carrying a wind turbine tower (7);
providing N first braces (11) and N second braces (12), wherein N is at least three, each brace (11, 12) having a first end part (11A, 12A) and a second end part (11B, 12B);
for each pair of one of the first braces (11) and one of the second braces (12), connecting the second end part (11B) of the first brace (11) to a first part of the tower support (8) at a first connection (24A), and connecting the second end part (12B) of the second brace (12) to a second part of the tower support (8) at a second connection (24B), and connecting the first end part (12A) of the second brace (12) to the first brace (11) at a third connection (24C), wherein the second part of the tower support (8) and the second connection (24B) are above the first part of the tower support (8) and the first connection (24A) when the support structure (3) is oriented for offshore operation, and wherein the combination of the tower support (8), the first brace (11), and the second brace (12) form a triangle in a vertical plane, and wherein the N pairs of braces (11, 12), relatively to a vertical central axis (23) of the tower support (8), are directed radially outwards from the tower support (8) in different directions about the vertical central axis (23);
characterised in that the method comprises
providing a shell unit (4) cast in concrete, the shell unit (4) comprising a base portion (4B) having a first side and a second side, and a cavity portion (4A) extending from the first side of the base portion (4B), the cavity portion (4A) comprising a cavity (17) inside the cavity portion (4A);
wherein the method further comprises at least one of A, B or C:
wherein in A, the method comprises providing the second side of the shell unit (4) with a curvature corresponding to a curvature of an outer surface (14) of the tower support (8) and attaching the second side to the outer surface (14) of the tower support (8) by a first hardening fixation material (18), and providing the first connection (24A) by inserting the second end part (11B) of the first brace (11) into the shell cavity (17) and providing a rigid fixation between the first brace (11) and the shell unit (4) by filling a second hardening fixation material (18) into the shell cavity (17) around the second end part (11B) of the first brace (11) and solidifying the fixation material (18);
wherein in B, the method comprises providing the second side of the shell unit (4) with a curvature corresponding to a curvature of an outer surface (14) of the tower support (8) and attaching the second side to the outer surface (14) of the tower support (8) by a first hardening fixation material (18), and providing the second connection (24B) by inserting the second end part (12B) of the second brace (12) into the shell cavity (17) and providing a rigid fixation between the second brace (11) and the shell unit (4) by filling a second hardening fixation material (18) into the shell cavity (17) around the second end part (12B) of the second brace (12) and solidifying the fixation material (18);
wherein in C, the method comprises providing the second side of the shell unit (4) with a curvature corresponding to a curvature of an outer surface (14) of the first brace (11) and attaching the second side to the outer surface (14) of the first brace (11) by a first hardening fixation material (18), and providing the third connection (24C) by inserting the first end part (12A) of the second brace (12) into the shell cavity (17) and providing a rigid fixation between the second brace (11) and the shell unit (4) by filling a second hardening fixation material (18) into the shell cavity (17) around the first end part (12A) of the second brace (12) and solidifying the fixation material (18).)

2. The method according to claim 1, wherein the method comprises providing the outer surface (14) underneath the shell unit (4) free from openings and preventing the first and the second fixation material (18) from flowing through the outer surface (14).

3. The method according to claim 1, wherein the method comprises providing the second side of the base (4B) with protrusions and positioning the shell unit (4) against the outer surface with the protrusions resting against the outer surface (14) for flow of the first fixation material between the protrusions.

4. The method according to claim 1 wherein the shell unit (4) comprises reinforcing steel elements (15) embedded in concrete of the shell unit (4), wherein the steel elements (15) extend out of the concrete of the shell unit (4) at an edge of the base (4B), and wherein the method comprises providing a further shell unit (4) with steel elements (15) extending out of the concrete of the further shell unit (4) at an edge of its base (4B), fastening the further shell unit (4) next to the shell unit (4) with an intermeshing overlap of the steel elements (15) extending out of the shell unit (4) and the further shell unit (4) in an overlap region, and filling the overlap region with a third hardening fixation material (18) and solidifying the third hardening fixation material (18) for fixing the shell unit (4) and the further shell unit (4) to each other by the third fixation material.

5. The method according to claim 1, wherein the shell unit (4) comprises a first interlock part (19A), and wherein the method comprises providing a further shell unit (4) with a second interlock part (19B), the first and second interlock part being counterparts of an interlock (19), wherein the method comprises fastening the further shell unit (4) next to the shell unit (4) and interlocking the first and second interlock parts (19A, 19B), wherein the method comprises filling a third hardening fixation material (18) into the interlock and solidifying the third hardening fixation material (18) for fixing the interlock.

6. The method according to claim 4, wherein at least one of the first, second and third hardening fixation material (18) is grout.

7. The method according to claim 1, wherein the method comprises providing a support flange (13), for example ring flange, fastened to the outer surface (14) and positioning the shell unit (4) against the flange (13) for support of the shell unit (4) at its end.

8. The method according to claim 1, wherein the method comprises providing a third set of N third braces (10) and interconnecting the first braces (11) by the third braces (10) for increasing rigidity between the first braces (11), wherein the interconnecting comprises fastening further shell units (4) on the surface (14) of the first braces (11) adjacent to the shell unit (4) and fastening each of the third braces (10) in a cavity (17) of these further shell units (4).

9. The method according to claim 8, wherein N is 3, and wherein the third braces (10) form a triangular structure.

10. The method according to claim 9, wherein the method comprises forming a tetrahedral structure by the first braces (11), the second braces (12) and the third braces (10).

11. The method according to claim , wherein the method comprises arranging the shell unit (4) and further shells units (4) side-by-side on the first brace (11) or the tower support (8) so as to form a ring around the first brace (11) or the tower support (8).

12. The method according to claim 1, wherein the method comprises assembling the offshore support structure (3) onshore or on land and providing a wind turbine (2) on top of the support structure (3), then, after assembly, moving the support structure (33) to an offshore point of destination and anchoring the support structure (3) to the seabed.

13. Method according to claim 12, wherein the method comprises providing the support structure with buoyancy tanks (22) and installing the support structure (3) as a floating structure.
